(19) United States
(12) Patent Application Publication
(10) Pub. No.: US 2009/0071468 A1
(43) Pub. Date: Mar. 19, 2009

(54) HEATING UNIT FOR HEATING A PATIO

(76) Inventor: Mark Andrew Nicholson, Essex (GB)

Correspondence Address: Joseph Iandiorio or Kirk Teska;Iandiorio & Teska, 260 Bear Hill Road, Waltham, MA, 02451-1018, US

(21) Appl. No.: 10/585,287

(22) PCT Filed: Jan. 20, 2005
(86) PCT No.: PCT/GB2005/000177

§ 371 Date: Dec. 1, 2008

(30) Foreign Application Priority Data
Jan. 23, 2004 (GB) 0401505.3
Nov. 22, 2004 (GB) 0425642.6

(51) Int. Cl. F24C 3/04; G06F 17/00

(52) U.S. Cl. 126/92 B; 705/418

(57) ABSTRACT

A heating unit (2) for heating a patio (4), which heating unit (2) comprises a heater portion (8) which provides heat for the patio (4) by burning gas from a gas container (6), and a meter (10), and the heating unit (2) being such that the meter (10) is a token-operated or coin-operated meter which allows the passage of gas from the gas container (6) to the heater portion (8) on receipt of at least one token (12) or coin, and the passage of the gas is only for a predetermined time period after which at least one further token (12) or coin is required for allowing the passage of more of the gas for a further predetermined time period.

This invention relates to a heating unit for heating a patio.

Heating units for heating a patio are known. The known heating units comprise a gas container and a heater portion which provides heat for the patio by burning gas from the gas container. The heating units are often used by the proprietors of commercially run premises such for example as public houses, cafes and restaurants for heating patios and thereby encouraging customers to use the patios at times when the patios might otherwise be too cold for comfortable use. Extended use of the patios can increase trade, for example by providing increased space for use by customers, or simply by enabling customers to remain in a preferred outdoor environment for longer than they would otherwise have done due to the fact that they do not become prematurely cold as they would do without the heating unit.

With the above use of the heating units, a problem arises in that the heating units are under the control of the proprietor of the commercial premises, and the heating units are generally left on for the duration of business. It often occurs that the heating units are used for heating patios when customers are not present. This represents a wastage of gas which in turn represents loss of profit.

It is an aim of the present invention to obviate or reduce the above mentioned problem.

Accordingly, in one non-limiting embodiment of the present invention there is provided a heating unit for heating a patio, which heating unit comprises a heater portion which provides heat for the patio by burning gas from a gas container, and a meter, and the heating unit being such that the meter is a token-operated or coin-operated meter which allows the passage of gas from the gas container to the heater portion on receipt of at least one token or coin, and the passage of the gas is only for a predetermined time period after which at least one further token or coin is required for allowing the passage of more of the gas for a further predetermined time period.

With the present invention, the heating unit can be under the control of a customer. The customer simply inserts at least one token or coin whereupon the heating unit provides heat for a predetermined time period. At the end of that time period, the customer can choose whether or not to pay for heating for a further predetermined time period. Basically, the customer will be paying for heating only for required time periods. Proprietors of commercial premises do not have to pay for operation of the heating unit although they can do so if they wish. Heating of empty patios can be avoided.

The heating unit may be one in which the meter is such that each predetermined time period is the same. Thus, for example, each predetermined time period may be twenty minutes, thirty minutes, forty minutes, or whatever period is required.

The heating unit may be such that it provides a predetermined minimum number of the same predetermined time periods when starting from a full quantity of gas in the gas container. Thus, for example, a proprietor of commercial premises will be able to know that when the gas container is full, and with each predetermined time period being the same, the predetermined number of the tokens or coins to a predetermined value that will be obtained from each full gas container. This enables the proprietor of the commercial premises to work out an appropriate charge rate in order to ensure that the heating unit pays for itself, in addition to attracting persons to use the patio. For example, if one token is able to be purchased for one pound, and if insertion of one token in the meter gives a twenty minutes predetermined time period, then the heating unit may provide forty of the predetermined time periods for each full gas container.

The heating unit may be one in which the meter is positioned between the heater portion and a base part of the heating unit.

The heating unit may include the gas container.

When the meter is positioned between the heater portion and the base part of the heating unit, and when the heating unit includes the gas container, then the heating unit may be of a pole-like appearance having the gas container as a tubular gas container at the base part of the heating unit, the heater portion at a top part of the heating unit, and the meter in a tubular conduit which extends between the gas container and the heater portion.

In an alternative embodiment of the invention, the heating unit may be one which is such that it does not include the gas container, in which the heating unit has connector means for connecting to a gas container remote from the heating unit, and in which the gas container has supply means for supplying a plurality of the heating units.

In all embodiments of the invention, the heater portion may include a reflector for reflecting downwardly heat from the heater portion. Generally, the heating unit may be of any suitable and appropriate size and shape.

The heating unit may include securing means for securing the heating unit in a chosen position in order to prevent theft of the heating unit. The securing means may secure the heating unit to a floor of the patio. Theft of the heating unit will be more of a problem when the heating unit operates on coins rather than tokens. For this reason, it is preferred that the meter is a token-operated meter.

The present invention also provides heating apparatus for heating a patio, which heating apparatus comprises the heating unit of the invention, and token-dispensing means for dispensing tokens in response to the payment. The payment may be made in cash, for example in the form of coins. The token-dispensing means may be positioned remote from the heating unit and in a more secure area than the heating unit because the token-dispensing means can contain cash which will attract thieves.

Embodiments of the invention will now be described solely by way of example and with reference to the accompanying drawings in which:

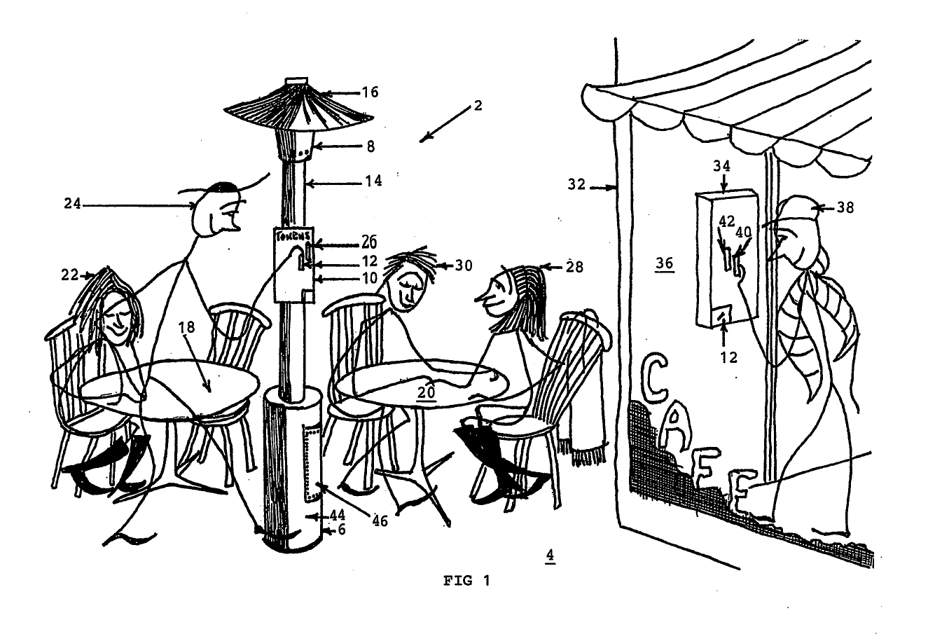

FIG. 1 shows a first heating unit in use;

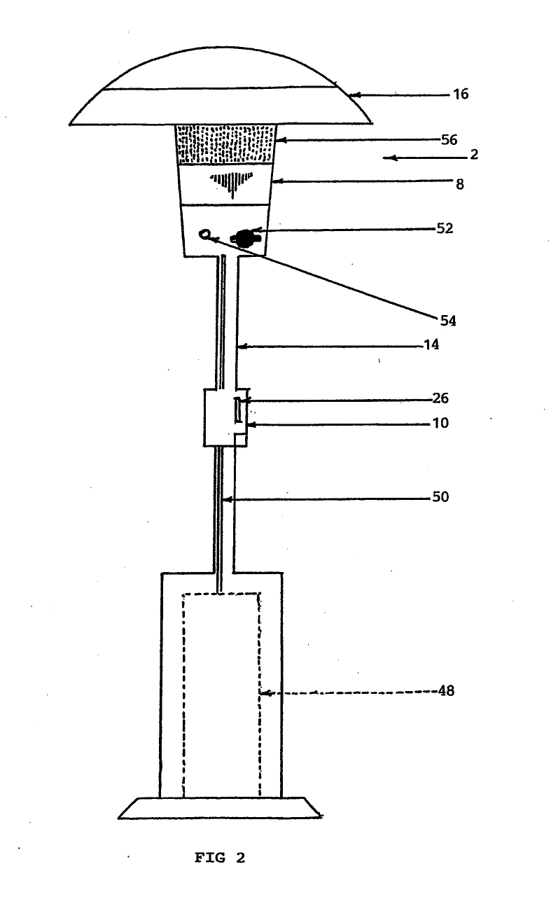

FIG. 2 shows in more detail the heating unit shown in FIG. 1;

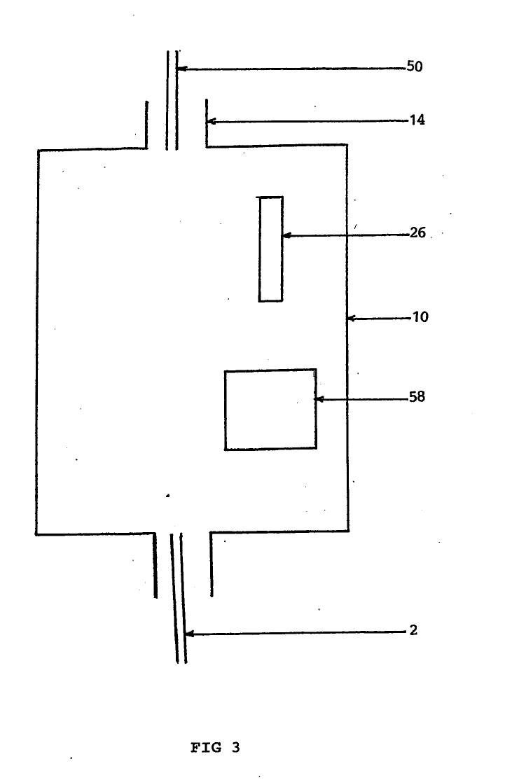

FIG. 3 is an enlarged view of a meter used in the heating unit shown in FIGS. 1 and 2;

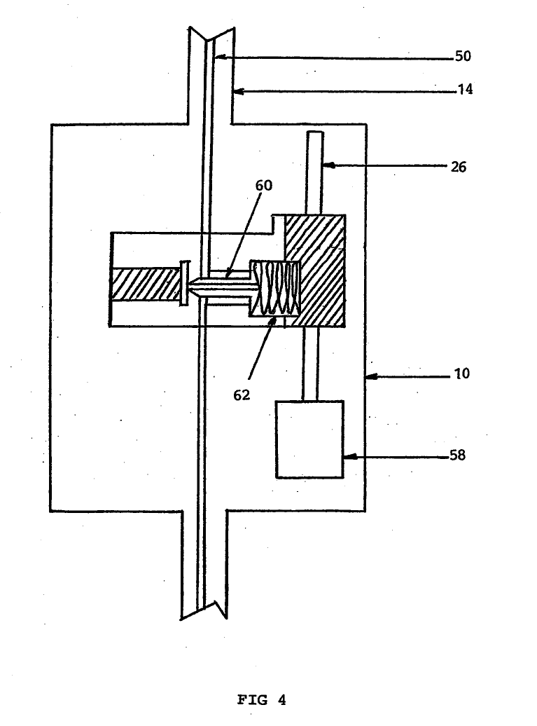

FIG. 4 is a section through the meter shown in FIG. 3;

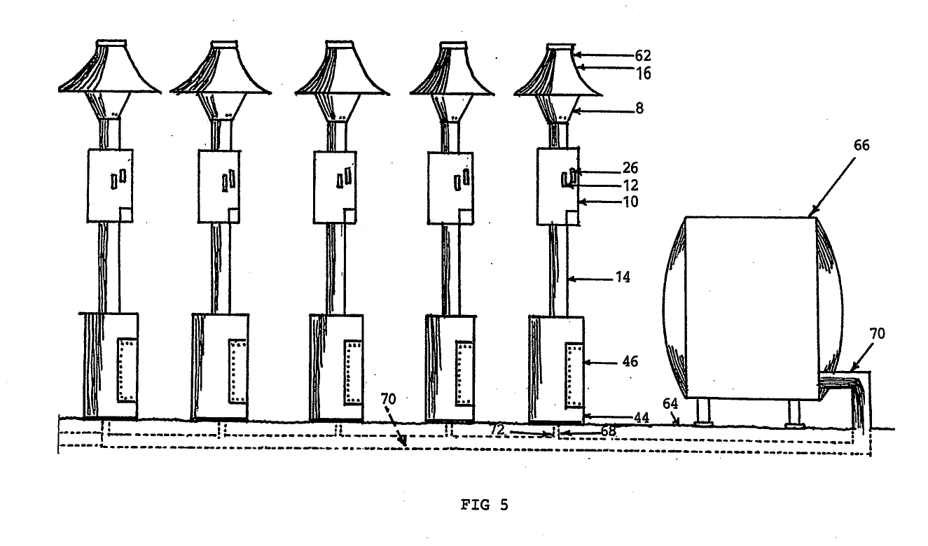

FIG. 5 shows a second heating unit in use;

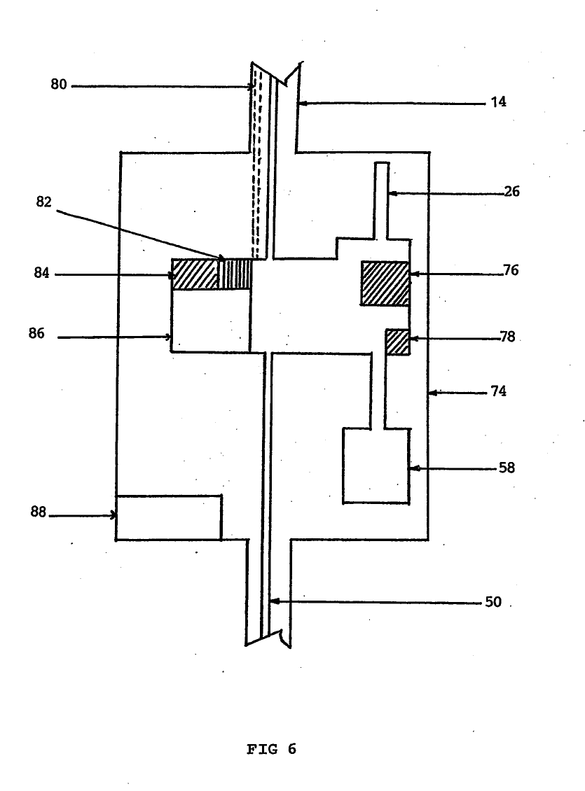

FIG. 6 is a section through part of a second meter that may be used in the heating unit of the invention; and

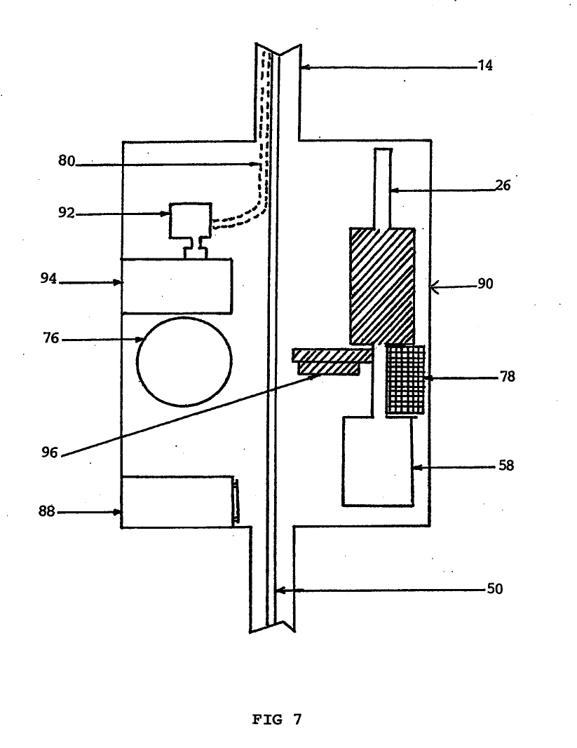

FIG. 7 is a section through a third meter that may be used in the heating unit of the present invention.

Referring to FIGS. 1-4, there is shown a heating unit 2 for heating a patio 4. The heating unit 2 comprises a gas container 6 and a heater portion 8 which provides heat for the patio 4 by burning gas from the gas container 6. A meter 10 is positioned between the gas container 6 and the heater portion 8.

The heating unit 2 is such that the meter 10 is a token-operated meter which allows the passage of gas from the gas container 6 to the heater portion 8 on receipt of a token 12. The passage of the gas is only for a predetermined time period, after which a further token 12 is required for allowing the passage of more of the gas for a further predetermined time period.

The meter is such that each predetermined time period is the same. For example, each predetermined time period may be of twenty minutes duration. The heating unit 2 is also such that it provides a minimum number of the same predetermined time periods when starting from a full quantity of gas in the gas container 6. For example, the heating unit 2 may provide forty of the predetermined time periods when starting from a full quantity of gas in the gas container. This will then require the insertion of forty of the tokens 12 into the meter 10. If each token 12 costs one pound, then a proprietor of commercial premises operating the patio 4 would know that each gas container 6 would earn forty pounds. If this sum is in excess of the cost of providing a refill gas container 6, then the heating unit 2 can be seen to be operating at a commercial profit, in addition to providing heating for the patio 4 and thus attracting customers to the patio 4.

As can best be seen from FIGS. 1 and 2, the heating unit 2 is of a pole-like appearance having the gas container 6 as a tubular gas container at a base of the hearing unit 2, the heater portion 8 as a heater head at a top part of the heating unit 2, and the meter 10 in a tubular conduit 14 which extends between the gas container 6 and the heater portion 8.

The heater portion 8 includes a reflector 16 for reflecting downwardly heat from the heater portion 8.

FIG. 1 shows the heating unit 2 being positioned adjacent to tables 18, 20 on the patio. The table 18 is shown being occupied by a female person 22. A male person 24 is shown about to insert a token 12 into a slot 26 in the meter 10. The table 20 is shown occupied by a female person 28 and a male person 30. The patio 4 is in front of commercial premises in the form of a cafe 32. Token-dispensing means 34 is mounted on a wall 36 inside the cafe 32. A male person 28 is shown inserting a one pound coin 40 into a slot 42 in the token-dispensing means 34 in order to obtain a token 12 from the token-dispensing means 34. The token-dispensing means 34 and the heating unit 2 together form heating apparatus for heating the patio 4.

As can be seen from FIG. 1, the gas container 6 comprises an outer holder 44 having a door 46. An actual container 48 (see FIG. 2) is inserted through the door 46 into the holder 44, from where it connects to a pipe 50 (see FIG. 2) which extends through the tubular conduit 14.

FIG. 2 shows how the heater portion 8 comprises a gas flow control knob 52 and an ignition button 54 for igniting the gas from the gas container 6 at the heater portion 8. The heater portion 8 and the gas container 6 may be of the same general construction as those employed in known patio heating units. Thus the heater portion 8 may have an incandescent portion 56 which glows with heat during the burning of the gas. The reflector 16 reflects the gas downwardly.

FIG. 3 shows in more detail the slot 26 in the meter 10. Also shown in FIG. 3 is a change chute 58 for giving change from the meter 10 if the meter 10 is to be a coin-operated meter 10 rather than a token-operated meter 10.

FIG. 4 is a section through the meter shown in FIG. 3. As can be seen from FIG. 4, the meter 10 includes a valve 60 which is spring biased by a spring 62 and which extends across the pipe 50 in order to block the pipe 50 and thus prevent the passage of gas from the gas container 6 to the heater portion 8. The valve 60 operates to close the pipe 50, when a predetermined time period bought by the token 12 being inserted into the slot 26, has expired. The meter 10 may operate on the same general principal as known gas meters for providing gas supplies to houses in response to receiving cash.

Referring now to FIG. 5, there are shown six heating units 62 which are located on a patio 64 and which are for heating the patio. The heating units 62 are similar to the heating unit 2 and similar parts have been given the same reference numerals for ease of comparison and understanding.

In FIG. 5, the plurality of heaters 62 are each supplied with gas from a separate gas container 66. Thus the individual heaters 62 do not contain a gas container in their holders 44. The heaters 62 look like the heater 2 and can be manufactured substantially the same. However, with the heaters 62, the gas is supplied from the gas container 66. Each heating unit 62 has connector means 68 for connecting a common gas pipe 70 to the heating units 62. Each connector means 68 includes a pipe 72 and a connector (not shown) for connecting the pipe 72 in a gas-type manner to a pipe like the pipe 50 shown in FIG. 2 and which is positioned inside the tubular conduit 14. The pipe 70 forms supply means which is from the gas container 66 and which is for supplying a plurality of the heating units 62 as shown.

Referring to FIG. 6, similar parts as in previous Figures have been given the same reference numerals for ease of comparison and understanding.

In FIG. 6 it will be seen that there is shown a meter 74 which is an alternative to the meter 10. The meter 74 has the pipe 50 in the tubular conduit 14. The meter 74 also has the slot 26. Associated with the slot 26 are a timer 76, a micro switch 78, wires 80 to a thermocouple, a micro processor 82, an intelligent relay 84, a circuit board 86 and a battery 88.

The meter 74 operates such that a coin or token is put into the slot 26. The coin or token activates the micro switch 78 when the coin or token drops through the slot 26. The micro switch 78 activates the intelligent relay 84. The intelligent relay 84 in turn activates the timer 76 which is connected to the thermocouple with the aid of the circuit board 86 and the microprocessor 82. The battery 88 is a low voltage battery. The battery 88 provides electricity for the electronics contained within the housing of the meter 74. A low voltage current is obtained from the battery 88 following the insertion of a coin or a token into the slot 26. The low voltage current is thus able to control indirectly the operation of the thermocouple within the heating element. The operation of the thermocouple can now be such that its electrical current is controlled by the electronics within the housing of the meter 74. The thermocouple is able, for example via a thermomagnet, to release or close the valve controlling the gas flow on demand.

FIG. 7 shows a meter 90. Similar parts as in the meter 74 have been given the same reference numerals for ease of comparison and understanding. It will be seen that the meter 90 has a tilt switch 92, a solenoid relay 94 and an internal coin counter 96.

The meter 90 operates such that a coin or token is placed through the slot 26. This causes the micro switch 78 to switch on a coin/token receiver. The solenoid relay 94 is triggered and this pushes the tilt switch 92 into an upright working position. After a predetermined time period provided by the timer 76, the tilt switch 92 can be rocked over automatically in order to break the electrical circuit created within the thermocouple which in turn operates a thermomagnet valve which opens and closes to control the gas flow to the heater element. The battery 88 may be used to power the electrical components within the meter 90. Alternatively, simple mechanical components may be employed. The internal coin/token counter is used to measure usage of the patio heater and terminates the usage after a predetermined number of coins or tokens have been deposited into the meter 78. This is a simple and effective way to operate the patio heater by means of a payment meter.

It is to be appreciated that the embodiments of the invention described above with reference to the accompanying drawings have been given by way of example only and that modifications may be effected. Thus, for example, the heating units 2, 62 can be of a different shape to that shown in FIGS. 1, 2 and 5. The heating units 2, 62 can be provided with securing means (not shown) for securing the heating units 2, 62 to the patios 4, 64 respectively in order to prevent theft of the heating unit 2. The cafe 32 could be any other form of business premises, for example a public house or a restaurant. The patios 4, 64 can be any patios 4, 64 and they can be of any size, location and construction suitable for receiving persons in an environment which may sometimes require heating from patio heaters such for example as the heating unit 2 shown in FIGS. 1 and 2, or the heating units 62 shown in FIG. 5. The heating units 2, 62 may burn any suitable and appropriate gas, for example propane or butane.

1. A heating unit for heating a patio, which heating unit comprises a heater portion which provides heat for the patio by burning gas from a gas container, and a meter, and the heating unit being such that the meter is a token-operated or coin-operated meter which allows the passage of gas from the gas container to the heater portion on receipt of at least one token or coin, and the passage of the gas is only for a predetermined time period after which at least one further token or coin is required for allowing the passage of more of the gas for a further predetermined time period.

2. A heating unit according to claim 1 in which the meter is such that each predetermined time period is the same.

3. A heating unit according to claim 2 in which the heating unit provides a predetermined minimum number of the same predetermined time periods when starting from a full quantity of gas in the gas container.

4. A heating unit according to any one of the preceding claims in which the meter is positioned between the heater portion and a base part of the heating unit.

5. A heating unit according to any one of the preceding claims and including the gas container.

6. A heating unit according to claims 4 and 5 which is of a pole-like appearance having the gas container as a tubular gas container at the base part of the heating unit, the heater portion at a top part of the heating unit, and the meter in a tubular conduit which extends between the gas container and the heater portion.

7. A heating unit according to any one of claims 1-4 which is such that it does not include the gas container, in which the heating unit has connector means for connecting to a gas container remote from the heating unit, and in which the gas container has supply means for supplying a plurality of the heating units.

8. A heating unit according to any one of the preceding claims in which the heater portion includes a reflector for reflecting downwardly heat from the heater portion.

9. A heating unit according to any one of the preceding claims and including securing means for securing the heating unit in a chosen position in order to prevent theft of the heating unit.

10. A heating unit according to claim 9 in which the securing means secures the heating unit to a floor of the patio.

11. A heating apparatus for heating a patio, which heating apparatus comprises a heating unit according to any one of the preceding claims, and token-dispensing means for dispensing tokens in response to payment.
